(19) United States
(12) Patent Application Publication
(10) Pub. No.: US 2016/0026278 A1
(43) Pub. Date: Jan. 28, 2016

(54) TOUCH PANEL AND MANUFACTURING METHOD THEREOF

(71) Applicant: Samsung Display Co., Ltd., Yongin-city (KR)

(72) Inventors: Jong Won LEE, Seongnam-si (KR); Seung Ho Nam, Seongnam-si (KR); Jae Ho You, Gwangmyeong-si (KR); Sung Jin Jang, Daejeon (KR); Byoung Won Choi, Asan-si (KR)

(21) Appl. No.: 14/618,855

(22) Filed: Feb. 10, 2015

(30) Foreign Application Priority Data
Jul. 25, 2014 (KR) 10-2014-0095093

(51) Int. Cl. G06F 3/041; G06F 1/16

(52) U.S. Cl. CPC G06F 3/041; G06F 1/16; G06F 2203/04103

(57) ABSTRACT

A touch panel including a cover glass; a transparent electrode layer disposed on a portion of the cover glass; a refractive index control layer disposed on the cover glass and the transparent electrode layer; and an adhesive layer disposed on the refractive index control layer. The refractive index control layer may include a single layer having sequentially different refractive indexes from the transparent electrode layer to the adhesive layer.

### CROSS-REFERENCE TO RELATED APPLICATION

This application claims priority from and the benefit of Korean Patent Application No. 10-2014-0095093, filed on Jul. 25, 2014, which is hereby incorporated by reference for all purposes as if fully set forth herein.

### BACKGROUND

1. Field

Exemplary embodiments relate to a touch panel and a manufacturing method thereof.

2. Discussion of the Background

A touch panel is used to input information by pressurizing a predetermined portion of a screen displayed on the panel. Recently, touch panels have been utilized in a large number of display devices as a result of their relative ease of use.

In general, the touch panel may be a capacitive type, a resistive type, a surface ultrasonic wave type, or an infrared ray type to extract coordinates of the pressurized portion and input information.

Among these types, the resistive type is typically lowest in cost, but includes two different layers physically contacting each other to acquire the coordinates such that when the device is used over a long period of time, its surface becomes increasingly susceptible to damage as a result of the physical contact.

Compared to the resistive type, when a user approaches a conductor, such as his finger, toward a transparent electrode layer, or when a user touches the conductor with his finger and the permittivity of the transparent electrode layer is changed, the capacitive type uses a change of capacitance to detect whether the conductor approaches or contacts the transparent electrode layer, and generates a switching signal according to a detection result. Many versions of the capacitive type have been developed and utilized because the capacitive type overcomes many of the disadvantages of the resistive type.

However, the capacitive-type touch panel tends to generate different values of reflectivity for a region in which the transparent electrode layer is formed and for a region in which the transparent electrode layer is not formed, resulting in the transparent electrode being to undesirably visible from the outside.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide a touch panel for reducing reflectivity, improving transmittance, and preventing a transparent electrode from being visible from the outside.

Additional aspects will be set forth in the detailed description which follows, and, in part, will be apparent from the disclosure, or may be learned by practice of the inventive concept.

An exemplary embodiment of the present invention discloses a touch panel including: a cover glass; a transparent electrode layer pattern-formed in a portion of the cover glass; a refractive index control layer disposed on the cover glass and the transparent electrode layer; and an adhesive layer disposed on the refractive index control layer. The refractive index control layer may be a single layer having sequentially different refractive indexes from the transparent electrode layer to the adhesive layer.

An exemplary embodiment of the present invention also discloses a method for manufacturing a touch panel, including: pattern-forming a transparent electrode layer on a portion of a cover glass; forming a refractive index control layer on the cover glass and the transparent electrode layer; and forming an adhesive layer on the refractive index control layer. The refractive index control layer may be a single layer having sequentially different refractive indexes from the transparent electrode layer to the adhesive layer.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a cross-sectional view of a touch panel according to an exemplary embodiment of the present invention.

FIG. 2 is a graph illustrating improvement of visibility of a touch panel according to an exemplary embodiment of the present invention.

FIG. 3 is a graph illustrating improvement of visibility of a touch panel according to another exemplary embodiment of the present invention.

FIG. 4 shows a process flowchart of a method for manufacturing a touch panel according to an exemplary embodiment of the present invention.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, is regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

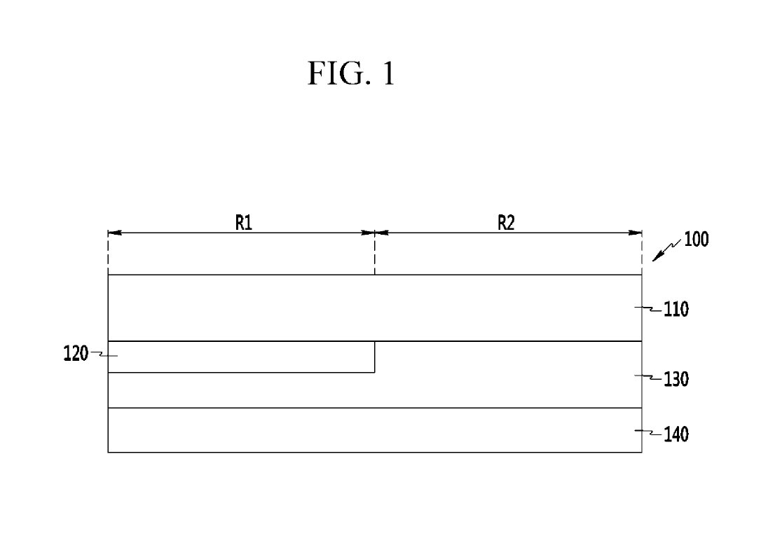

FIG. 1 illustrates a cross-sectional view of a touch panel according to an exemplary embodiment of the present invention.

Referring to FIG. 1, the touch panel 100 includes a cover glass 110, a transparent electrode layer 120, a refractive index control layer 130, and an adhesive layer 140.

The cover glass 110 can be made of tempered glass or general plate glass, or the cover glass 110 can be formed with a material including, for example, at least one of polyethylene terephthalate (PET), polyethylene naphthalate (PEN), polyethersulfone (PES), polycarbonate (PC), polypropylene (PP), and polymethylmethacrylate (PMMA). The cover glass 110 can be formed to have a thickness in a range of 100-1000 μm. When the thickness of the cover glass 110 is less than 100 μm, the film becomes more difficult to manufacture, and when the thickness of the cover glass 110 is greater than 1000 μm, the entire touch panel becomes undesirably thick.

The transparent electrode layer 120 may be pattern-formed on a portion of the is cover glass 110.

The material of the transparent electrode layer 120 may include one of indium tin oxide (ITO), indium zinc oxide (IZO), indium tin zinc oxide (ITZO), carbon nanotubes (CNT), and a silver nanowire.

The refractive index control layer 130 is formed on the cover glass 110 on which the transparent electrode layer 120 is formed, and the adhesive layer 140 is formed on the refractive index control layer 130.

The adhesive layer 140 can be formed with an optically clear adhesive (OCA) film, and can bond upper and lower layers.

A refractive index of the transparent electrode layer 120 is may be in a range of 1.7 to 2.2, and the refractive index of the adhesive layer 140 may be in a range of 1.4 to 1.6.

That is, a pattern region R1, in which the transparent electrode layer 120 is pattern-formed, and a non-pattern region R2, in which the transparent electrode layer 120 is not formed, have different refractive indexes, thereby generating a difference in reflectivity of the visible light, and making the transparent electrode layer 120 undesirably visible. To solve this problem, the refractive index control layer 130 is provided between the transparent electrode layer 120 and the adhesive layer 140.

The refractive index control layer 130 can be formed with a single layer having sequentially different refractive indexes from the transparent electrode layer 120 to the adhesive layer 140.

The refractive index control layer 130 can be formed to have a relatively high refractive index at a portion adjacent to the transparent electrode layer 120, and have a relatively low refractive index at a portion adjacent to the adhesive layer 140.

In further detail, a portion of the refractive index control layer 130 adjacent to the transparent electrode layer 120 may have the same refractive index as the transparent electrode layer 120, and a portion thereof adjacent to the adhesive layer 140 may have the same refractive index as the adhesive layer 140. This arrangement results in a reduction in the difference of reflectivity between the pattern region R1 and the non-pattern region R2, thereby reducing the chance of the transparent electrode layer 120 being visible from the outside.

The refractive index control layer 130 may include, for example, an organic material that is an acryl-based compound having a refractive index in a range of 1.4 to 1.6. However, other organic materials having a low refractive index are also usable.

In this instance, the refractive index control layer 130 may be formed to have a thickness greater than 1 μm.

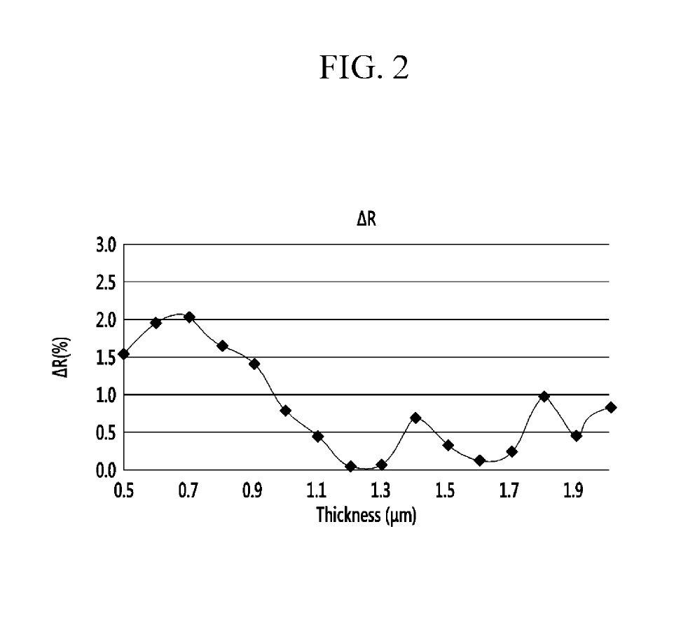

FIG. 2 is a graph illustrating improvement of visibility of a touch panel according to an exemplary embodiment of the present invention, and indicates changes in a reflectivity difference between the pattern region R1 of the transparent electrode layer 120 and the non-pattern region R2 according to a thickness of the refractive index control layer 130 formed with an organic layer.

Referring to FIG. 2, when the refractive index control layer 130 is formed of an organic layer having a thickness of about 1.2 μm, the reflectivity difference (ΔR) is a minimum, and when a thickness of the refractive index control layer 130 is greater than 1 μm, the reflectivity difference (ΔR) between the pattern region R1 and the non-pattern region R2 is less than 1%.

In general, when the reflectivity difference (ΔR) is less than 1%, the transparent electrode layer 120 is not visible from the outside.

That is, the touch panel can prevent the transparent electrode layer 120 from being visible from the outside by forming a refractive index control layer 130 having a thickness greater than 1 μm thick when the refractive index control layer 130 is an organic layer arranged between the transparent electrode layer 120 and the adhesive layer 140.

In another exemplary embodiment of the present invention, the refractive index control layer 130 can be a single layer formed with inorganic materials, including a low refractive inorganic material having a refractive index in a range of 1.4 to 1.6 and a high refractive inorganic material having the refractive index in a range of 1.7 to 2.2. For example, the high refractive inorganic material may include one of TiOₓ, NbOₓ, and SiNₓ, and the low refractive material may include SiOₓ.

Further, when the refractive index control layer 130 is formed with an inorganic layer, it can be made thinner than a refractive index control layer formed with an organic layer. For example, the refractive index control layer 130 formed with an inorganic layer can be formed to have a thickness in a range of 0.5 to 2.0 μm.

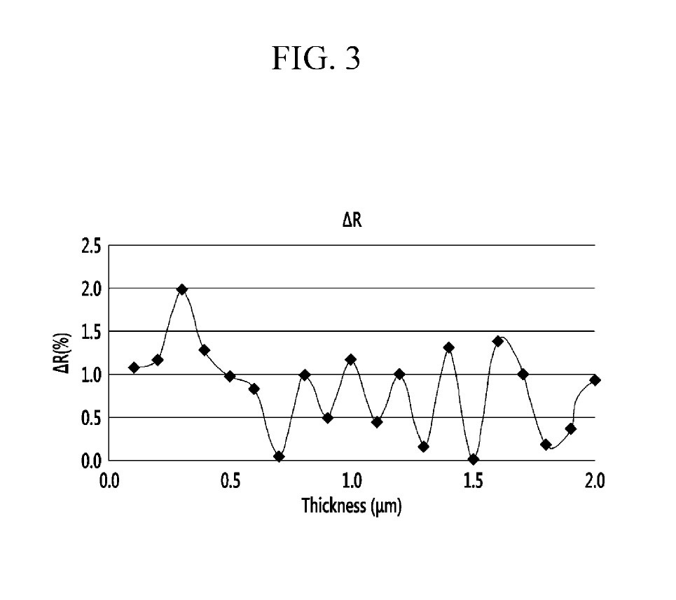

FIG. 3 illustrates an improvement of visibility of a touch panel according to another exemplary embodiment of the present invention, indicating changes of a reflectivity difference between the pattern region R1 of the transparent electrode layer 120 and the non-pattern region R2 according to a thickness of the refractive index control layer 130 formed with an inorganic layer.

Referring to FIG. 3, when the refractive index control layer 130 is formed of an inorganic layer having a thickness of about 0.7 μm, the reflectivity difference (ΔR) is a minimum, and when the refractive index control layer 130 has a thickness in a range of 0.5 to 2.0 μm, the reflectivity difference (ΔR) between the pattern region R1 and the non-pattern region R2 is about 1%.

That is, the reflectivity difference (ΔR) between the pattern region R1 and the non-pattern region R2 is reduced to be about 1%, and the visibility of the transparent electrode layer 120 from the outside is reduced by forming the refractive index control layer 130 formed with an inorganic material to have a thickness in a range of 0.5 to 2.0 μm.

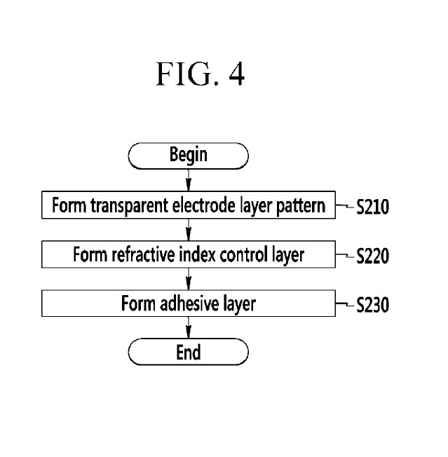

A method for manufacturing a touch panel according to an exemplary embodiment of the present invention will now be described with reference to FIG. 4.

FIG. 4 shows a process flowchart of a method for manufacturing a touch panel according to an exemplary embodiment of the present invention.

Referring to FIG. 4, the method for manufacturing a touch panel includes forming a transparent electrode layer pattern (S210), forming a refractive index control layer (S220), and forming an adhesive layer (S230).

In step (S210), a transparent electrode layer is pattern-formed on a portion of cover glass.

Here, the cover glass is a surface of the touch panel, and a part of human body may directly contact the cover glass. Thus, the cover glass may be made of tempered glass or general plate glass, or made with a material including at least one of polyethylene terephthalate (PET), polyethylene naphthalate (PEN), polyethersulfone (PES), polycarbonate (PC), polypropylene (PP), and polymethylmethacrylate (PMMA).

The transparent electrode layer can be made of various transparent conductive materials, such as indium tin oxide (ITO), indium zinc oxide (IZO), indium tin zinc oxide (ITZO), carbon nanotubes (CNT), or a silver nanowire.

The conductive material is formed to be a thin film according to a sputtering is deposition method. The thickness of the thin film can be in a range of 0.01 to 0.02 μm when made of ITO. This is because there may be a problem of conductivity, and mechanical rigidity may be reduced, when the thickness of the thin film is less than 0.01 μm. On the other hand, it may be difficult to perform an etching process for forming a pattern when the thickness of the thin film is greater than 0.02 μm.

However, the present invention may also utilize other deposition methods, such as a plasma deposition method, depending on the circumstances.

The deposited transparent conductive layer is etched to form a pattern. The etching method, in this instance, includes known etching methods, such as photolithography or plasma etching.

In step (S220), a refractive index control layer is formed on the cover glass on which the transparent electrode layer is formed.

The refractive index control layer can be formed with a single layer having sequentially different refractive indexes from the transparent electrode layer to the adhesive layer.

Here, the refractive index control layer can be formed with an organic layer or an inorganic layer.

As an exemplary embodiment of the present invention, a method for forming a refractive index control layer with an organic layer will now be described.

The refractive index control layer can be formed by dispersing an inorganic material with the refractive index in a range of 1.7 to 2.2 in a solvent composed of an organic material having a refractive index in a range of 1.4 to 1.6.

Here, for example, an acryl-based compound with a low refractive index is usable is for the organic material, and at least one of TiOₓ, NbOₓ, and SiNₓ can be used for the inorganic material. However, other organic materials with a refractive index in a range of 1.4 to 1.6, and other inorganic materials with a refractive index in a range of 1.7 to 2.2, may also be used.

The percentage by mass of the refractive index control layer that constitutes the inorganic material may be greater than 1% and less than 5%. Transparency is reduced when the percentage is greater than 5%.

That is, when the organic material having a low refractive index and the inorganic material having a high refractive index, are mixed, the inorganic material settles, and as a result, a bottom portion that is near the transparent electrode layer has a relatively high refractive index, and a top portion that is distant from the transparent electrode layer has a relatively low refractive index, thereby forming a single layer with sequentially different refractive indexes from the transparent electrode layer to the adhesive layer.

Further, the thickness of the refractive index control layer formed with an organic layer can be formed to be greater than 1 μm. When the thickness of the refractive index control layer formed with an organic layer is greater than 1 μm, the reflectivity difference between the pattern region in which the transparent electrode layer is formed and the non-pattern region the transparent electrode layer is not formed becomes less than 1%, as shown, for example, in FIG. 2, thereby resulting in the transparent electrode layer not being visible from the outside.

A method for forming a refractive index control layer with an inorganic layer according to another exemplary embodiment of the present invention will now be described.

The refractive index control layer can be formed with a single layer of inorganic materials including a low refractive inorganic material having a refractive index in a range of 1.4 to 1.6, and a high refractive inorganic material having a refractive index in a range of 1.7 to 2.2. For example, the high refractive inorganic material may be formed with one of TiOₓ, NbOₓ, and SiNₓ, and the low refractive material may be formed with SiOₓ.

In this instance, the low refractive material SiOₓ and the high refractive materials TiOₓ, NbOₓ, and SiN_{X} can form a film by using a sputtering method, a chemical vapor deposition (CVD) method, or a sol-gel method, and the refractive index control layer having a relatively high refractive index at the bottom that is near the transparent electrode layer and a relatively low refractive index at the top that is distant from the transparent electrode layer can be formed to be a single layer by controlling a processing condition including a source such as a gas, a target, or a precursor.

For example, the processing condition is controllable by using a method for adjusting an injection amount of the source with respect to time, or a method for using purging in the case of the chemical vapor deposition method, or using a method for using a difference of settling rates as time passes, in the case of the sol-gel method.

In this instance, the thickness of the refractive index control layer formed with an inorganic layer can be in a range of 0.5 to 2.0 μm.

The reflectivity difference (ΔR) between the pattern region R1 and the non-pattern region R2 is reduced to be about 1% and the visibility of the transparent electrode layer 120 from the outside is reduced by forming the refractive index control layer 130 with an inorganic material to be 0.5 to 2.0 μm thick, as shown, for example, in FIG. 3.

Compared to formation of the refractive index control layer with an organic layer, the refractive index control layer formed with an inorganic layer can be formed to have a thickness less than 1 μm, have a greater rigidity than the case of the organic layer, and function as a passivation layer.

Accordingly, the refractive index control layer with sequentially different refractive indexes from the transparent electrode layer to the adhesive layer is formed to be a single layer by applying a single layer process, thereby reducing a manufacturing cost through simplification of the process.

In step (S230), an adhesive layer is formed on the refractive index control layer.

The adhesive layer can be formed with the optically clear adhesive (OCA) film.

Although not shown, the touch panel 100 can be provided on an image display device. The image display device receives information that is input by the touch panel 100 and outputs an image, and it is attachable to the adhesive layer 140. The image display device includes a liquid crystal display device (LCD), an organic light emitting display device (OLED), and a plasma display panel (PDP).

According to inventive concepts disclosed herein, the refractive index control layer having sequentially different refractive indexes, ranging from the same refractive index as the transparent electrode layer to the same refractive index as the adhesive layer between the transparent electrode layer and the adhesive layer, is configured to reduce reflectivity, improve transmittance, and accordingly prevent the transparent electrode layer from being visible from the outside.

According to disclosed inventive concepts, the refractive index control layer having sequentially different refractive indexes, ranging from the transparent electrode layer to the adhesive layer, may be formed as a single layer by applying a single layer process, thereby simplifying production processes and reducing manufacturing costs.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A touch panel comprising:
a cover glass;
a transparent electrode layer disposed on a portion of the cover glass;
a refractive index control layer disposed on the cover glass and the transparent electrode layer; and
an adhesive layer disposed on the refractive index control layer,
wherein the refractive index control layer comprises a single layer having sequentially different refractive indexes from the transparent electrode layer to the adhesive layer.

2. The touch panel of claim 1, wherein:
the refractive index control layer has a refractive index equal to that of the transparent electrode layer at a portion adjacent to the transparent electrode layer; and
the refractive index control layer has a refractive index equal to that of the adhesive layer s at a portion adjacent to the adhesive layer.

3. The touch panel of claim 1, wherein:
the refractive index control layer has a relatively high refractive index at a portion adjacent to the transparent electrode layer; and
the refractive index control layer has a relatively low refractive index at a portion s adjacent to the adhesive layer.

4. The touch panel of claim 1, wherein the refractive index of the transparent electrode layer is in a range of 1.7 to 2.2, and the refractive index of the adhesive layer is in a range of 1.4 to 1.6.

5. The touch panel of claim 1, wherein the refractive index control layer comprises an organic layer, and the refractive index control layer has a thickness greater than 1 μm.

6. The touch panel of claim 1, wherein the refractive index control layer comprises an inorganic layer, and the refractive index control layer has a thickness in a range of 0.5 to 2.0 μm.

7. The touch panel of claim 1, wherein the cover glass comprises at least one of polyethylene terephthalate (PET), polyethylene naphthalate (PEN), polyethersulfone (PES), polycarbonate (PC), polypropylene (PP), and polymethylmethacrylate (PMMA).

8. The touch panel of claim 1, wherein the transparent electrode layer comprises a transparent conductive material.

9. A method for manufacturing a touch panel, comprising:
pattern-forming a transparent electrode layer on a portion of a cover glass;
forming a refractive index control layer on the cover glass and the transparent electrode layer; and
forming an adhesive layer on the refractive index control layer,
wherein the refractive index control layer comprises a single layer having sequentially different refractive indexes from the transparent electrode layer to the adhesive layer.

10. The method of claim 9, wherein the forming of a refractive index control layer comprises dispersing an inorganic material having a refractive index in a range of 1.7 to 2.2 in a solvent comprising an organic material having a refractive index in a range of 1.4 to 1.6.

11. The method of claim 10, wherein the organic material comprises an acryl-based compound, and the inorganic material comprises at least one of TiOₓ, NbOₓ, and SiNₓ.

12. The method of claim 10, wherein the inorganic material comprises a percentage by mass of the refractive index control layer that is greater than 1% and is less than 5%.

13. The method of claim 12, wherein the refractive index control layer has a thickness greater than 1 μm.

14. The method of claim 9, wherein the refractive index control layer comprises a low refractive inorganic material having a refractive index in a range of 1.4 to 1.6 and a high refractive inorganic material having a refractive index in a range of 1.7 to 2.2.

15. The method of claim 14, wherein the high refractive inorganic material comprises one of TiOₓ, NbOₓ, and SiNₓ, and the low refractive material comprises SiOₓ.

16. The method of claim 14, wherein the refractive index control layer has a thickness in a range of 0.5 to 2.0 μm.

17. The touch panel of claim 1, wherein the transparent electrode layer is pattern-formed on the cover glass.

18. The touch panel of claim 1, wherein the transparent electrode layer comprises at least one of indium tin oxide (ITO), indium zinc oxide (IZO), indium tin zinc oxide (ITZO), carbon nanotubes (CNT), and a silver nanowire.
